(19) United States
(12) Patent Application Publication
(10) Pub. No.: US 2008/0224997 A1
(43) Pub. Date: Sep. 18, 2008

(54) Computer Cursor Control Method and Apparatus

(75) Inventors: Chih Lung Lo, Sijhih City (TW); Wen Sheng Kuo, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP., Sijhih City (TW)

(21) Appl. No.: 12/048,315

(22) Filed: Mar. 14, 2008

(30) Foreign Application Priority Data
Mar. 16, 2007 (TW) 96109215

(51) Int. Cl. G06F 3/033

(52) U.S. Cl. 345/157

(57) ABSTRACT

A computer cursor control apparatus operating in a mouse mode or a non-mouse mode in response to a switch signal is provided. When operating in the mouse mode, the computer cursor control apparatus outputs a wireless signal to a wireless signal receiving unit for determining the displacement of the computer cursor control apparatus to generate a cursor-moving signal, and then display the cursor-moving signal on the monitor of a host. On the other hand, in the non-mouse mode, the pressuring signal is packeted into the wireless signal transmitted from the computer cursor control apparatus such that the host receives not only the cursor-moving signal through the wireless receiving module, but also receives the pressuring signal. In addition, the host displays the cursor-moving signal on the monitor as a moving trace with a thickness depending on the pressuring signal.

This application claims the benefit of priority based on Taiwan Patent Application No. 096109215, filed on Mar. 16, 2007, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a computer cursor control apparatus. More particularly, the present invention relates to a computer cursor control apparatus and method for wirelessly controlling the movement of the computer cursor.

2. Descriptions of the Related Art

FIG. 1 illustrates a schematic diagram of a prior art mouse pen. With a pen-like appearance, the mouse pen may be used like a common pen to control the movement of the computer cursor. Because the mouse pen feels like an ordinary pen, users have much more flexibility than using an ordinary mouse. However, some mouse manufactures have provided additional functions to the mouse pen by taking advantage of its pen-like appearance. As a result, the mouse pen can also be used as a digital pen for inputting handwriting traces, characters or graphics directly onto a monitor.

Although the mouse pen is currently available for use as a digital pen, it fails to provide the same touch sense as a brush or a paintbrush. Thus, the thickness of the handwriting trace cannot vary based on the contact pressure exerted by the user. In view of these problems, the present inventors propose an improved technical solution.

### SUMMARY OF THE INVENTION

This invention provides a computer cursor control apparatus and a method. By sensing the pressure exerted during the handwriting operation, the moving trace of the computer cursor control apparatus can vary according to the sensing pressure.

To solve the above problems, a computer cursor control apparatus comprising a main body, a contact portion, a pressure sensing unit, a control module, and a wireless transmission module is provided. The main body has a cap, with the contact portion disposed in the cap and exposed out of the main body. The pressure sensing unit and the wireless transmission module are both disposed in the main body. The pressure sensing unit is in contact with the contact portion, and senses the pressure actuated from the contact portion to generate a pressuring signal that is transmitted to the control module. The control module is electrically connected to both the pressure sensing unit and the wireless transmission module for controlling the wireless transmission module to transmit a wireless signal. When receiving a switch signal, the control module is adapted to control the wireless transmission module to packet the pressuring signal into the wireless signal.

A computer cursor control method that allows the computer cursor control apparatus to wirelessly transmit a signal to a host is also provided. The method comprises the following steps: allowing the first wireless receiver and second wireless receiver to receive a wireless signal transmitted by the computer cursor control apparatus, wherein the first wireless receiver is spaced apart a specific distance from the second wireless receiver; sensing the pressure actuated from the computer cursor control apparatus to generate a pressuring signal; determining that a switch signal of the computer cursor control apparatus is enabled; packeting the pressuring signal into the wireless signal transmitted from the computer cursor control apparatus; computing a cursor-moving signal of the computer cursor control apparatus according to a time difference between the wireless signals received from the first wireless receiver and the second wireless receiver; transmitting the cursor-moving signal and the pressuring signal to the host; and translating the cursor-moving signal into a moving trace via a drive software then displaying the moving trace on a monitor after the host receives the cursor-moving signal and the pressuring signal, wherein the moving trace has a thickness that varies according to the pressuring signal.

In accordance with the computer cursor control apparatus and the method of this invention, a pressure sensing unit is disposed in the main body for sensing the pressure actuated from the computer cursor control apparatus while the apparatus is moving on a desktop, so that the moving trace of the computer cursor control apparatus varies in thickness depending on the sensed pressure.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a schematic diagram of a prior art mouse pen;

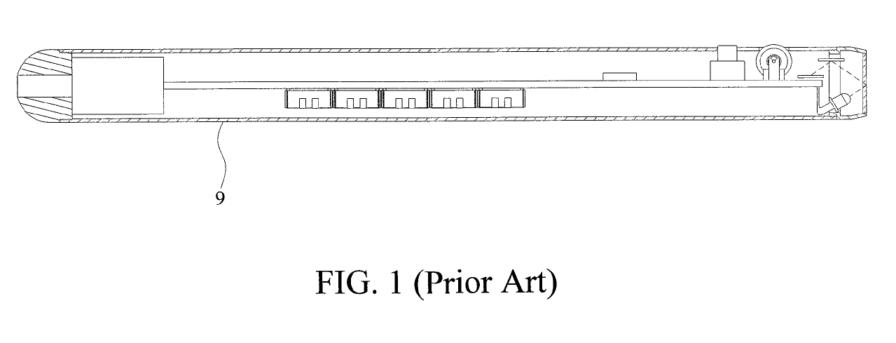

FIG. 2 illustrates a block diagram of a computer cursor control apparatus of this invention;

FIG. 3 illustrates a schematic diagram of a first wireless receiver and a second wireless receiver receiving a wireless signal in accordance with this invention;

FIG. 4 illustrates a schematic diagram of a first embodiment of this invention;

FIG. 5 illustrates a schematic diagram of a second embodiment of this invention;

FIG. 6 illustrates a schematic diagram of a third embodiment of this invention; and

FIG. 7 is a flow chart of the control operations performed by the computer cursor control apparatus of this invention.

### DESCRIPTION OF THE PREFERRED EMBODIMENT

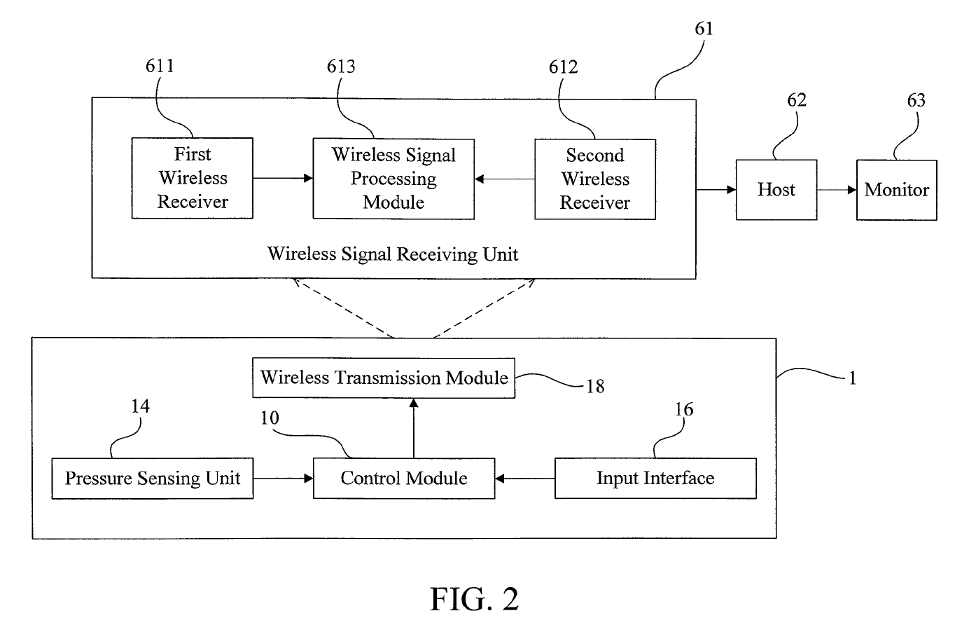

FIG. 2 illustrates a computer cursor control apparatus 1 of this invention. The computer cursor control apparatus 1 transmits a wireless signal to a host 62. The host 62 receives the wireless signal through a wireless signal receiving unit 61. After being processed by the host 62, the wireless signal is used as a signal for performing a computer cursor operation, a paintbrush operation, or a character recognition operation and will be displayed on a monitor 63.

Except when receiving a wireless signal from the computer cursor control apparatus 1, the wireless signal receiving unit 61 can further determine the displacement of the computer cursor control apparatus 1 to output the cursor-moving signal to the host 62. The wireless signal receiving unit 61 comprises a first wireless receiver 611, a second wireless receiver 612, and a wireless signal processing module 613. The wireless signal processing module 613 is electrically connected with the first wireless receiver 611 and the second wireless receiver 612. Both the first wireless receiver 611 and the second wireless receiver 612, which are spaced apart from each other with a fixed distance, are used to receive a wireless signal that is transmitted from the computer cursor control apparatus 1. The wireless processing module 613 computes the cursor-moving signal according to the time difference between the wireless signals received by the first wireless receiver 611 and the second wireless receiver 612.

The computer cursor control apparatus 1 comprises a control module 10, a pressure sensing unit 14, an input interface 16, and a wireless transmission module 18. The control module 10 is electrically connected to the pressure sensing unit 14, the input interface 16, and wireless transmission module 18 for control. The control module 10 is further used to control the wireless transmission module 18 to transmit a wireless signal continuously or intermittently to the wireless signal receiving unit 61. The wireless signal provides the wireless signal receiving unit 61 with the information to determine the variation in displacement of the computer cursor control apparatus 1.

The pressure sensing unit 14 is configured to synchronously sense pressure actuated from the computer cursor control apparatus 1 during the moving process and to output the pressuring signal to the control module 10. The pressuring signal makes a moving trace of the computer cursor control apparatus 1, which varies in thickness, as the computer cursor control apparatus 1 operates in the paintbrush mode.

The input interface 16 provides a mouse function interface and a function switching interface. The mouse function interface may include basic functions such as the left mouse button, the right mouse button, and the mouse wheel. Other functions may include the inputting of the operation signal to the control module 10, and the outputting of the operation signal via the wireless transmission module 18 by the control module 10. The input interface 16 can also add other desired functional buttons. The function switching interface is used by the computer cursor control apparatus 1 to switch between the mouse function and the non-mouse function. In this invention, the non-mouse function allows the computer cursor control apparatus 1 to operate in a paintbrush mode or a character recognition mode. The function switching interface provides a switch signal to the control module 10 for deciding the function of the computer cursor control apparatus 1.

In this invention, when receiving the switch signal, the control module 10 controls the computer cursor control apparatus 1 to operate in the non-mouse function; otherwise, when not receiving the switch signal, the control module 10 controls the computer cursor control apparatus 1 to operate in the mouse function.

Therefore, when the computer cursor control apparatus 1 is operating in the mouse function, the control module 10 controls the wireless transmission module 18 to output a wireless signal to the wireless signal receiving unit 16 for computing the wireless signal to obtain a cursor-moving signal and transmits it to the host 62. After receiving the cursor-moving signal from the wireless signal receiving unit 61, the host 62 processes the cursor-moving signal to display the moving direction of the cursor on the monitor 63.

On the other hand, when the computer cursor control apparatus 1 is operating in the non-mouse function, the control module 10 packets the pressuring signal into the wireless signal for output to the wireless receiving unit 61. As a result, the wireless signal receiving unit 61 not only computes the cursor-moving signal to the host 62, but also transmits the pressuring signal in the wireless signal to the host 62 at the same time. After receiving the cursor-moving signal and the pressuring signal via the wireless signal receiving unit 61, the host 62 decides the functional mode according to the predetermined drive software, processes the cursor-moving signal and the pressuring signal to display a result on the monitor 63. Here, the predetermined drive software can execute either the paintbrush mode or the character recognition mode.

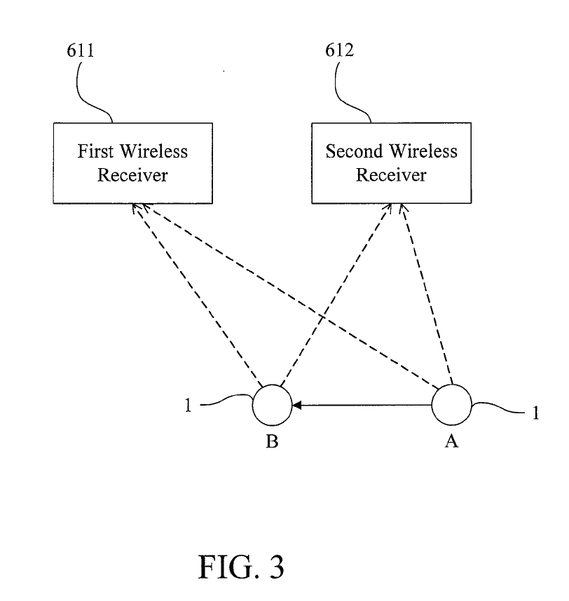

FIG. 3 illustrates the first wireless receiver 611 and the second wireless receiver 612 receiving a wireless signal in accordance with this invention. In FIG. 3, the computer cursor control apparatus 1 is shown to move from a position “A” to a position “B”, as the computer cursor control apparatus 1 is in the initial position “A”. The wireless signals received by the first wireless receiver 611 and the second wireless receiver 612 have a time difference ΔTa. When the computer cursor control apparatus 1 moves to the position “B”, the wireless signals received by the first wireless receiver 611 and the second wireless receiver 612 have a time difference ΔTb. Consequently, the wireless signal processing module 613 is able to compute the cursor-moving signal of the computer cursor control apparatus 1 according to variation between the time differences ΔTa and ΔTb.

Hereinafter, the embodiments of the computer cursor control apparatus 1 will be described in detail with reference to the block diagram shown in FIG. 2.

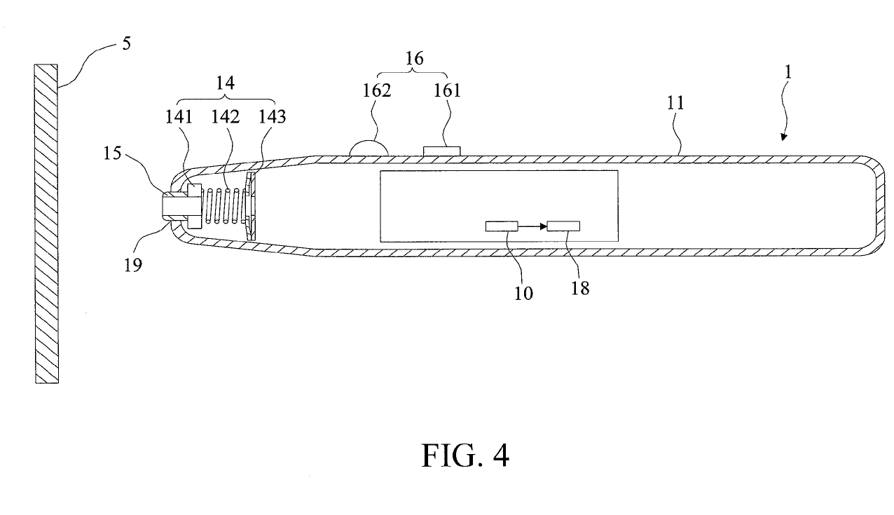

FIG. 4 illustrates a computer cursor control apparatus 1 in accordance with the first embodiment of this invention. The computer cursor control apparatus 1 comprises a pressure sensing unit 14, a control module 10 and a wireless transmission module 18 disposed in the main body 11. The main body 11 is a hollow penholder and is formed with a cap 19 at the front end thereof. The cap 19 has a contact portion 15 for the computer cursor control apparatus 1 to make contact with the working surface 5 to operate in either the paintbrush mode or character recognition mode.

The pressure sensing unit 14 is disposed immediately adjacent to the contact portion 15 for sensing the pressure actuated from the contact portion 15 to generate a pressuring signal. The pressure sensing unit 14 may be implemented by a pressure sensor 141, a flexible portion 142 and a fixed portion 143. The pressure sensor 141 is disposed immediately adjacent to one side of the contact portion 15 and is connected to the fixed portion 143 by the flexible portion 142, such that the pressure sensing unit 14 may experience a flexible deformation in response to the pressure actuated from the contact portion 15. As a result, when operated by a user, the computer cursor control apparatus 1 may yield a handwriting effect such as a paintbrush or a brush. In an alternative design, those skilled in the art can swap the locations of the pressure sensor 141 and the fixed portion 143, making the pressure sensing unit 14 more flexible.

An input interface 16, disposed on the outer surface of the main body 11, comprises a switch 161, a plurality of mouse buttons 162, and a mouse wheel (not shown) for operation by the user. The mouse buttons 162 can be used as either the left or right mouse button. The switch 161 is for outputting the switch signal to the control module 10. Functions of the control module 10 have already been shown in FIG. 2, and therefore will not be described again.

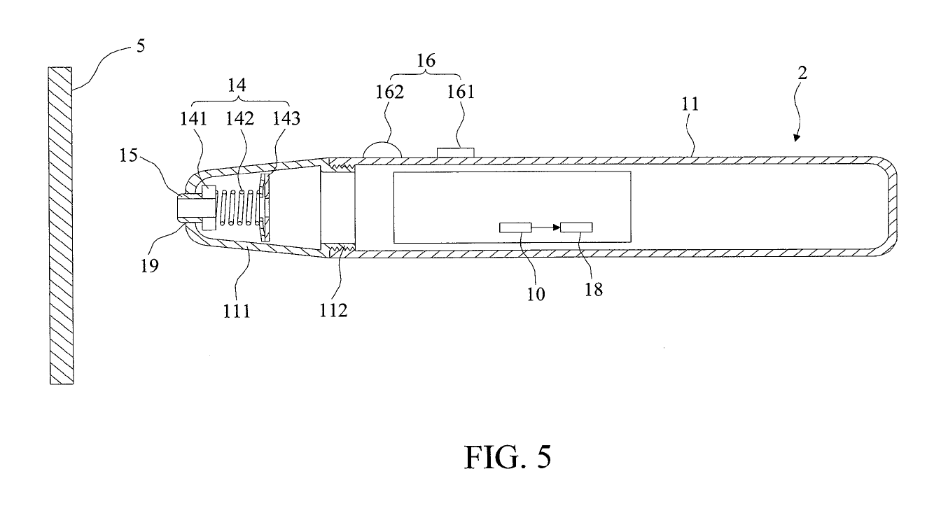

FIG. 5 illustrates a computer cursor control apparatus 2 in accordance with the second embodiment of this invention is depicted. The computer cursor control apparatus 2 shown in FIG. 5 differs from the computer cursor control apparatus 1 in FIG. 4 mainly because the head portion 111 of the main body 11 is designed as a replaceable structure. The head portion 111 comprises the pressure sensing unit 14 and the contact portion 15. The head portion 111 of the computer cursor control apparatus 2 has a connecting portion 112 for connecting with the main body 11 by means of thread, rabbet, or other movable connecting means. For the computer cursor control apparatus 2, any element inside the head portion 111 can be replaced as it fails to work.

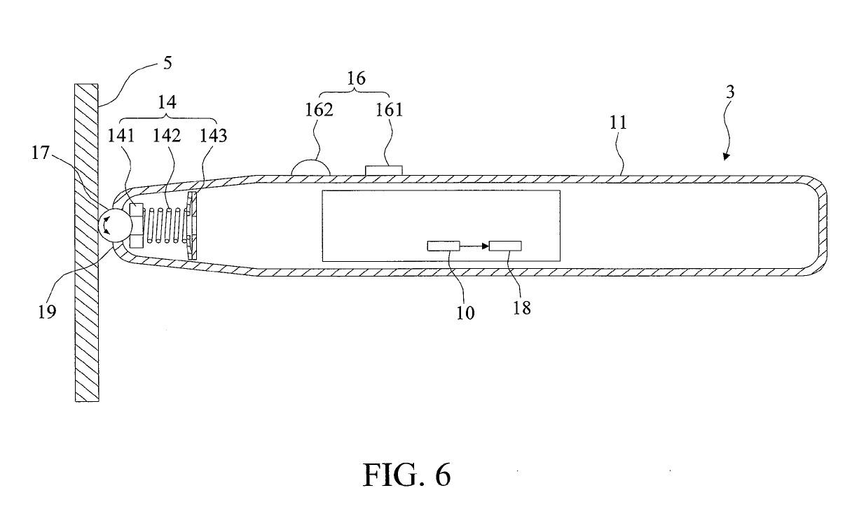

FIG. 6 illustrates a computer cursor control apparatus 3 in accordance with the third embodiment of this invention. The computer cursor control apparatus 3 shown in FIG. 6 differs from the computer cursor control apparatus 1 in FIG. 4 because the contact portion 15 in FIG. 4 is replaced by a ball 17 instead. With the rolling movement of the ball 17, the computer cursor control apparatus 3 operates more like a paintbrush.

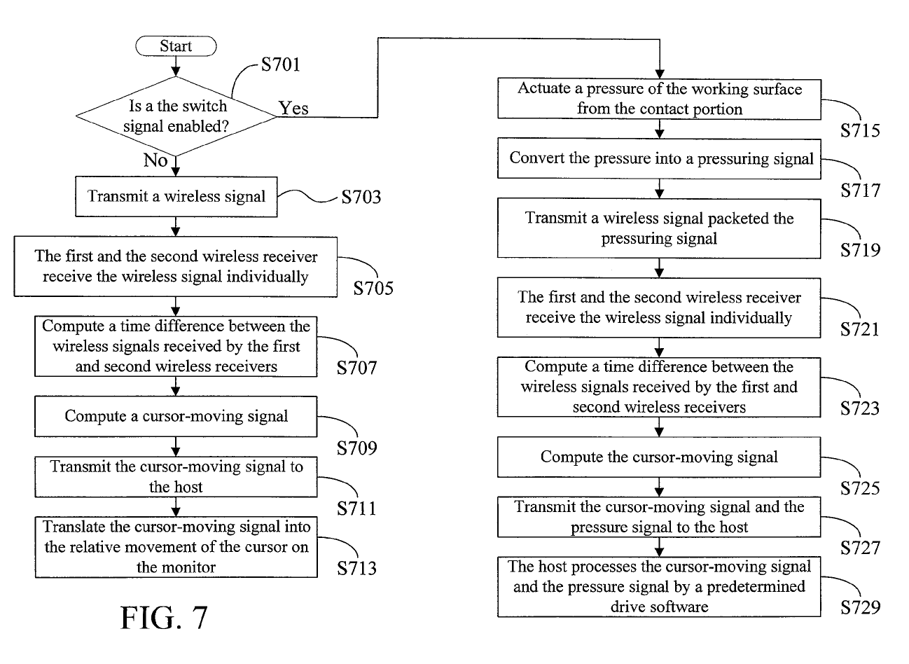

FIG. 7 illustrates a flow chart of the control operations performed by the computer cursor control apparatus of this invention. For the hardware structure described herein, refer to both FIG. 2 and FIG. 4. The control flow comprises the follow steps: initially, the control module 10 determines whether the switch signal is enabled by the switch 161 (step S701), in response to the result of the determination, the control module 10 decides whether the computer cursor control apparatus 1 should operate in a mouse function or a non-mouse function.

If the result in step S701 is to disable, the control module 10 controls the computer cursor control apparatus 1 to operate in the mouse function, and the control module 10 also controls the wireless transmission module 18 to transmit a wireless signal to the wireless signal receiving unit 61 (step S703). The wireless signal is then received by the first wireless receiver 611 and the second wireless receiver 612 of the wireless signal receiving unit 61 individually (step S705). Subsequently, the wireless signal processing module 613 computes a time difference between the wireless signals received by the first wireless receiver 611 and the second wireless receiver 612 (step S707). According to the time difference, the wireless signal processing module 613 computes a cursor-moving signal (step S709). Then the cursor-moving signal is transmitted to the host 62 (step S711), so that after receiving the cursor-moving signal, the host 62 translates it into the relative movement of the cursor on the monitor 63 (step S713).

On the other hand, if the result in step S701 is to enable, the control module 10 controls the computer cursor control apparatus 1 to operate in the non-mouse mode, the computer cursor control apparatus 1 moves, and a pressure of the working surface 5 is actuated from the contact portion 15 (step S715). Subsequently, the pressure actuated from the contact portion 15 is converted by the pressure sensing unit 14 into a pressuring signal (step S717). Next, the control module 10 controls the wireless transmission module 18 to transmit a wireless signal, and packets the pressuring signal into the wireless signal for output to the wireless signal receiving unit 61 (step S719). This wireless signal is then received by the first wireless receiver 611 and the second wireless receiver 612 of the wireless signal receiving unit 61 (step S721). Thereafter, the wireless signal processing module 613 computes the time difference between the wireless signals received by the first wireless receiver 611 and the second wireless receiver 612 (step S723). Then, according to this time difference, the wireless signal processing module 613 computes a cursor-moving signal (step S725). The cursor-moving signal and the pressuring signal are then transmitted to the host 62 (step S727) so that after receiving the cursor-moving signal and the pressuring signal, the host 62 processes them by a predetermined drive software (step S729).

In step S729, the drive software may be selected by a user. The user may choose the drive software for executing the paintbrush mode, in which case the cursor-moving signal is displayed on the monitor 63 as a moving trace, according to the pressuring signal. The cursor-moving signal will cause a variation in the thickness of the moving trace, so that the computer cursor control apparatus 1 may be used by the user as a paintbrush or a brush.

Alternatively, in step S729, the user may choose the drive software for executing the character recognition mode. In this case, the cursor-moving signal is displayed on the monitor 63 as a moving trace, which is recognized as the corresponding characters are outputted. The computer cursor control apparatus 1 may then be used by the user as a handwriting recognizing apparatus.

With the above descriptions, both the structure and the operations of the computer cursor control apparatus and the method for a computer cursor control apparatus to wirelessly transmit a signal to a host in accordance with this invention have been disclosed. In this invention, the wireless signal transmitted by the wireless transmission module 18 may be one an electromagnetic wave or a light wave. The main body 11 may be a transparent shell or an opaque shell (in case a light wave is used for the wireless signal). The wireless signal processing module 613 may compute the cursor-moving signal using an operation program residing therein, which may be implemented by those skilled in the art upon reviewing the disclosure of this invention and will not be described in detail herein.

In summary, the computer cursor control apparatus and the method thereof disclosed in this invention are characterized as follows:
1. The computer cursor control apparatus has a plurality of functions integrated therein, such as the functions of a mouse, a paintbrush, and a handwriting recognizing apparatus.
2. The user has the same touch sensitivity as a paintbrush or a brush, in which the handwriting trace is variable in thickness based on the pressure actuated from the handwriting process.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A computer cursor control apparatus, comprising:
a main body having a cap;
a contact portion disposed in the cap and exposed out of the main body;
a pressure sensing unit, disposed in the main body and being in contact with the contact portion, for sensing pressure actuated from the contact portion to generate a pressuring signal;
a wireless transmission module disposed in the main body; and
a control module, disposed in the main body and electrically connected with the pressure sensing unit and the wireless transmission module, for controlling the wireless transmission module to transmit a wireless signal;
wherein when receiving a switch signal, the control module is adapted to control the wireless transmission module to packet the pressuring signal into the wireless signal.

2. The computer cursor control apparatus of claim 1, wherein the main body is a hollow penholder.

3. The computer cursor control apparatus of claim 1, wherein the main body is a transparent shell.

4. The computer cursor control apparatus of claim 1, wherein the pressure sensing unit comprises a pressure sensor, a fixed portion, and a flexible portion, and the flexible portion is disposed between the fixed portion and the pressure sensor.

5. The computer cursor control apparatus of claim 1, wherein the pressure sensing unit deposed in the main body is replaceable.

6. The computer cursor control apparatus of claim 1, wherein the wireless signal is one of a light wave and an electromagnetic wave.

7. The computer cursor control apparatus of claim 1, further comprising an input interface, electrically connected with the control module, for generating an operation signal and the switch signal.

8. The computer cursor control apparatus of claim 7, wherein the input interface comprises a mouse button.

9. The computer cursor control apparatus of claim 7, wherein the input interface comprises a mouse wheel.

10. The computer cursor control apparatus of claim 7, wherein the input interface comprises a switch for generating the switch signal.

11. The computer cursor control apparatus of claim 7, wherein the contact portion is a ball.

12. A computer cursor control system, comprising:
a computer cursor control apparatus, comprising:
a main body having a cap;
a contact portion disposed in the cap and exposed out of the main body;
a pressure sensing unit, disposed in the main body and being in contact with the contact portion, for sensing pressure actuated from the contact portion to generate a pressuring signal;
a wireless transmission module disposed in the main body;
a control module, disposed in the main body and being electrically connected with the pressure sensing unit and the wireless transmission module, for controlling the wireless transmission module to transmit a wireless signal;
wherein when receiving a switch signal, the control module is adapted to control the wireless transmission module to packet the pressuring signal into the wireless signal; and
a wireless signal receiving unit, comprising:
a first wireless receiver for receiving the wireless signal;
a second wireless receiver for receiving the wireless signal, wherein the first wireless receiver is spaced apart a specific distance from the second wireless receiver;
a wireless signal processing module, electrically connected with the first and the second wireless receivers, for computing a cursor-moving signal of the computer cursor control apparatus according to a time difference between the wireless signals received from the first wireless receiver and the second wireless receiver.

13. A computer cursor control method for a computer cursor control apparatus to wirelessly transmit a signal to a host, the computer cursor control method comprising following steps of:
allowing a first wireless receiver and a second wireless receiver to receive a wireless signal transmitted by the computer cursor control apparatus individually, wherein the first wireless receiver is spaced apart a specific distance from the second wireless receiver;
sensing pressure actuated from the computer cursor control apparatus to generate a pressuring signal;
determining that a switch signal of the computer cursor control apparatus is enabled;
packeting the pressuring signal into the wireless signal transmitted from the computer cursor control apparatus;
computing a cursor-moving signal of the computer cursor control apparatus according to a time difference between the wireless signals received from the first wireless receiver and the second wireless receiver;
transmitting the cursor-moving signal and the pressuring signal to the host; and
translating the cursor-moving signal into a moving trace via a drive software and displaying the moving trace on a monitor after the host receives the cursor-moving signal and the pressuring signal, wherein the moving trace has a thickness being variable according to the pressuring signal.

14. The computer cursor control method of claim 13, wherein the pressuring signal is generated by a pressure sensing unit sensing the pressure actuated from the contact portion of the computer cursor control apparatus.

15. The computer cursor control method of claim 13, wherein the drive software is operated in a paintbrush mode for connecting the moving trace with the pressuring signal, and the thickness of the moving trace is variable according to the pressuring signal.

16. The computer cursor control method of claim 13, wherein the drive software is operated in a character mode for recognizing the moving trace as a character.

17. The computer cursor control method of claim 13, further comprising following steps of:
determining that the switch signal of the computer cursor control apparatus is disabled; and
transmitting the wireless signal from the computer cursor control apparatus to the first wireless receiver and the second wireless receiver.

18. The computer cursor control method of claim 17, further comprising following steps of:
computing a cursor-moving signal of the computer cursor control apparatus according to a time difference of the wireless signals received from the first wireless receiver and the second wireless receiver;
transmitting the cursor-moving signal to the host; and
translating the cursor-moving signal into a relative movement of a cursor on the monitor after the host receives the cursor-moving signal.

19. The computer cursor control method of claim 13, wherein the wireless signal is one of a light wave and an electromagnetic wave.
